(19) United States
(12) Patent Application Publication
(10) Pub. No.: US 2022/0358842 A1
(43) Pub. Date: Nov. 10, 2022

(54) INFORMATION PROCESSING APPARATUS, INFORMATION PROCESSING METHOD, AND DRIVING ASSISTANCE SYSTEM

(71) Applicant: SONY SEMICONDUCTOR SOLUTIONS CORPORATION, KANAGAWA (JP)

(72) Inventors: KOHEI KADOSHITA, KANAGAWA (JP); EIJI OBA, KANAGAWA (JP)

(21) Appl. No.: 17/620,916

(22) PCT Filed: Jun. 15, 2020
(86) PCT No.: PCT/JP2020/023343

§ 371 Date: Dec. 20, 2021

(30) Foreign Application Priority Data
Jun. 28, 2019 (JP) 2019-121048

(51) Int. Cl. G08G 1/16; G06V 20/56; G06V 20/59

(52) U.S. Cl. CPC G08G 1/16; G06V 20/56; G06V 20/597

(57) ABSTRACT

A first imaging section 201 captures an image of the vehicle exterior, and a second imaging section 202 captures an image of a driver. An image processing section 203 detects the driver's line of sight. An information acquisition section 205 acquires status information indicative of the surrounding environment. A driving parameter information generation section 206 generates driving parameter information by use of, as parameter information, the current position detected by a self-position detection section 204, travel control information generated by a travel control section, information indicative of the driver's line of sight, information indicative of the surrounding environment, and the like. A determination section 209 determines whether there is a danger on the basis of a difference between the driving parameter information indicative of the state of the vehicle or of its driver on one hand, and optimum parameter information indicative of an optimum state of the vehicle or of its driver in the current position and in the current surrounding environment on the other hand. An information presentation section 214 presents driving assistance information on the basis of a result of the determination. On the basis of the determination result, a travel control section 210 provides traveling assistance such as to reduce the difference in parameter information. The present technology enables appropriate driving assistance.

### TECHNICAL FIELD

The present technology relates to an information processing apparatus, an information processing method, and a driving assistance system and makes it possible to provide appropriate driving assistance.

### BACKGROUND ART

In recent years, apparatuses that provide driving assistance in such a manner as to keep the driver's attention in an appropriate state have been developed and utilized. For example, PTL 1 describes techniques in which the driver's line-of-sight probability distribution necessary for the steering operation and the driver's line-of-sight probability distribution expected from the visual feature quantities of an image corresponding to the driver's field of view are used to calculate an ideal line-of-sight probability distribution and in which a danger is determined to be present in a case where there occurs a predetermined difference between the driver's line-of-sight distribution and the ideal line-of-sight probability distribution, the result of the determination being thereupon output. PTL 2 describes techniques in which optimum attention allocation is calculated in consideration of surrounding circumstances indicative of obstacles and the like around the own vehicle as well as the position and the speed of the own vehicle, the calculated optimum attention allocation being compared with the driver's attention allocation detected from the driver's line of sight and face movements so as to remind the driver of the optimum attention allocation for safe driving.

### CITATION LIST

### Patent Literature

[PTL 1]

Japanese Patent Laid-open No. 2005-267108
[PTL 2]

Japanese Patent Laid-open No. 2004-178367

### SUMMARY

### Technical Problem

Meanwhile, for example, when the driving state of the own vehicle is not an ordinary state, in a case where an ideal state is calculated on the basis of information acquired regarding the own vehicle as described in the cited patent literature (e.g., an image corresponding to the driver's line of sight and the driver's field of view, or the result of detection of the surrounding circumstances indicative of obstacles and the like), the calculated ideal state is not an optimum state. That means appropriate driving assistance may not be provided.

It is therefore an object of the present technology to provide an information processing apparatus, an information processing method, and a driving assistance system that can provide appropriate driving assistance.

### Solution to Problem

According to a first aspect of the present technology, there is provided an information processing apparatus including a determination section configured to determine whether there is a danger on the basis of a difference between driving parameter information indicative of a state of a vehicle or of a driver thereof in a current position on one hand, and optimum parameter information indicative of an optimum state of the vehicle or of the driver in the current position and in a current surrounding environment on the other hand.

According to this technology, a driving parameter information generation section generates the driving parameter information that includes, as parameter information, either travel control information regarding the vehicle or information detected by use of an image captured of the driver and information indicative of the current position and the current surrounding environment. An information acquisition section acquires the information indicative of the surrounding environment as well as vehicle interior status and the like. Further, an image processing section performs image processing using the image captured of the driver, thereby detecting the state of the driver such as the driver's line of sight.

The determination section calculates a parameter difference evaluation value reflecting a difference in parameter information between the driving parameter information and each corresponding piece of the optimum parameter information. Using the parameter difference evaluation value thus calculated and a predetermined threshold value, the determination section determines whether there is a danger. For example, the determination section determines whether there is a danger on the basis of a result of comparison between a total value of the parameter difference evaluations values and a predetermined threshold value. Further, the determination section may determine whether there is a danger further by use of a result of comparison between the parameter difference evaluation value and a threshold value set beforehand for each piece of parameter information. Moreover, the determination section may set a weight on the parameter difference evaluation value, and determine whether there is a danger on the basis of the weighted parameter difference evaluation value. Furthermore, the weight or the threshold value may be set for each driver.

A driving assistance section provides driving assistance, based on a result of determination by the determination section and on the parameter difference evaluation value. For example, in a case where the determination section determines that there is a dangerous state, the driving assistance section presents the driving assistance information regarding the parameter information having a large difference on the basis of the parameter difference evaluation value. Also, in the case where the determination section determines that there is a dangerous state, the driving assistance section provides traveling assistance such as to reduce the difference of the parameter information having a large difference on the basis of the parameter difference evaluation value.

According to a second aspect of the present technology, there is provided an information processing method including causing a determination section to determine whether there is a danger on the basis of a difference between driving parameter information indicative of a state of a vehicle or of a driver thereof in a current position on one hand, and optimum parameter information indicative of an optimum state of the vehicle or of the driver in the current position and in a current surrounding environment on the other hand.

According to a third aspect of the present technology, there is provided a driving assistance system including an imaging section configured to capture an image of a driver, a travel control section configured to provide travel control of a vehicle, an information acquisition section configured to acquire information indicative of a surrounding environment, a driving parameter information generation section configured to generate driving parameter information by use of, as parameter information, either travel control information generated by the travel control section or information detected by use of the captured image acquired by the imaging section and information indicative of a current position, a determination section configured to determine whether there is a danger on the basis of a difference between the driving parameter information generated by the driving parameter information generation section on one hand, and optimum parameter information indicative of an optimum state of the vehicle or of the driver thereof in the current position and in a current surrounding environment on the other hand, and a driving assistance section configured to provide driving assistance on the basis of a result of determination by the determination section.

### BRIEF DESCRIPTION OF DRAWINGS

FIG. 1 is a diagram illustrating a configuration of an information processing system.

FIG. 2 is a diagram illustrating a configuration of a driving assistance system.

FIG. 3 is a diagram illustrating a configuration of an image processing section in a case in which a driver's line of sight is estimated.

FIG. 4 is a flowchart illustrating operations of the driving assistance system.

FIG. 5 is a diagram illustrating information included in driving parameter information.

FIG. 6 depicts diagrams each depicting an operation example of a case in which the driving parameter information includes driver information indicative of the driver's line of sight.

FIG. 7 is a diagram illustrating a configuration of a management apparatus.

FIG. 8 is a flowchart illustrating operations of the management apparatus.

### DESCRIPTION OF EMBODIMENT

An embodiment for implementing the present technology is described blow. The description is made in the following order.

1. Information processing system

2. Configuration of driving assistance system

3. Operations of driving assistance system

4. Configuration and operations of management apparatus

### <1. Information Processing System>

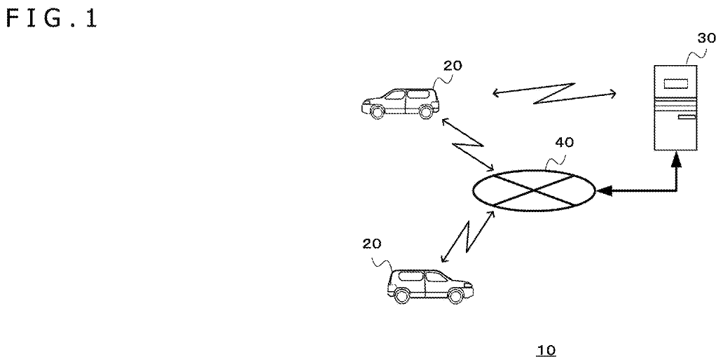

FIG. 1 illustrates a configuration of an information processing system that uses mobile objects to which the present technology can be applied. An information processing system 10 includes multiple mobile objects such as vehicles 20. Each vehicle 20 and a management apparatus 30 are interconnected either via a network 40 or without the intervention of the network 40. The vehicle 20 is equipped with a driving assistance system according to this technology. The driving assistance system determines whether there is a danger on the basis of a difference between driving parameter information indicative of the state of the vehicle or of its driver in the current position on one hand, and optimum parameter information indicative of an optimum state of the vehicle or of its driver in the current position and in the current surrounding environment on the other hand. On the basis of a result of the determination, the driving assistance system provides driving assistance such as to forestall the occurrence of a danger.

### <2. Configuration of Driving Assistance System>

Explained next is a configuration of the driving assistance system to which the information processing apparatus of the present technology can be applied.

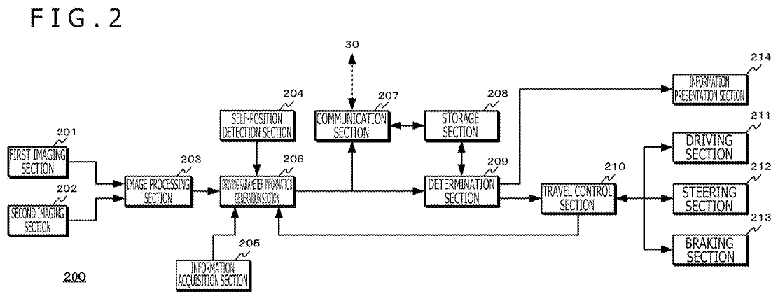

The vehicle 20 is equipped with a driving assistance system 200. FIG. 2 illustrates a configuration of the driving assistance system. The driving assistance system 200 uses a first imaging section 201, a second imaging section 202, an image processing section 203, a self-position detection section 204, an information acquisition section 205, a driving parameter information generation section 206, a communication section 207, a storage section 208, a determination section 209, a travel control section 210, a driving section 211, a steering section 212, a braking section 213, an information presentation section 214, and the like. It is to be noted that a portion of the driving assistance system 200 is also used as a portion of a control system that provides travel control of the vehicle 20.

The first imaging section 201 includes an imaging optical system including a focus lens and other parts, and an image sensor such as a CMOS (Complementary Metal Oxide Semiconductor) or a CCD (Charge Coupled Device). The first imaging section 201 is positioned in such a manner as to be able to capture images of the vehicle exterior such as the vehicle front. The first imaging section 201 outputs, to the image processing section 203, an exterior image acquired by capturing the vehicle exterior.

The second imaging section 202 includes, as with the first imaging section 201, an imaging optical system, an image sensor, and the like. The second imaging section 202 is positioned in such a manner as to be able to capture images of the driver of the vehicle. The second imaging section 202 outputs, to the image processing section 203, a driver's image acquired by capturing the driver.

The image processing section 203 detects the state of the driver and that of the vehicle exterior, based on the exterior image acquired by the first imaging section 201 and on the driver's image acquired by the second imaging section 202. The image processing section 203 estimates the driver's line of sight by use of the driver's image, for example. The line of sight, which is a straight line connecting the center of the eye with the center of the pupil, is estimated by the image processing section 203 detecting the position of the eye center and that of the pupil center.

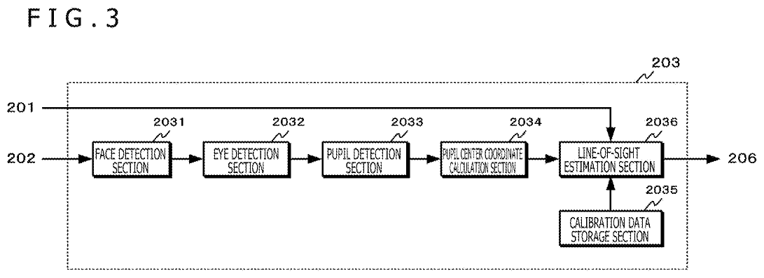

FIG. 3 illustrates a configuration of the image processing section in a case in which the driver's line of sight is estimated. The image processing section 203 includes a face detection section 2031, an eye detection section 2032, a pupil detection section 2033, a pupil center coordinate calculation section 2034, a calibration data storage section 2035, and a line-of-sight estimation section 2036.

The face detection section 2031 detects a face region of the driver by performing subject recognition processing by use of the driver's image. The face detection section 2031 outputs, to the eye detection section 2032, a result of detection of the face region and the driver's image, or the detected face region image.

The eye detection section 2032 detects the driver's eye by performing subject recognition processing by use of the face region image. The face detection section 2031 outputs, to the pupil detection section 2033, a result of detection of the eye and the driver's image, or an eye image indicative of the detected eye.

The pupil detection section 2033 detects the pupil of the eye by performing subject recognition processing by use of an eye region image. The pupil detection section 2033 outputs, to the pupil center coordinate calculation section 2034, the result of detection of the eye and the driver's image, or a pupil image indicative of the detected pupil.

The pupil center coordinate calculation section 2034 calculates the center coordinates of the pupil from the pupil image detected by the pupil detection section 2033. The pupil center coordinate calculation section 2034 outputs the calculated center coordinates to the line-of-sight estimation section 2036.

The calibration data storage section 2035 stores calibration data for correcting the position and the posture of the driver, the refraction of eyeglasses or contact lenses used by the driver, and effects of differences in eye shape between drivers and of corneal asphericity of the driver, for example.

The line-of-sight estimation section 2036 estimates the center of the eye by elliptically approximating the pupil image to find the minor axis direction of the ellipse and on the basis of the calibration data, for example. Further, the line-of-sight estimation section 2036 estimates a specific exterior position of the driver's line of sight, based on the direction connecting the eye center with the pupil center calculated by the pupil center coordinate calculation section 2034 and on the exterior image acquired by the first imaging section. The line-of-sight estimation section 2036 outputs a result of the estimation to the driving parameter information generation section 206.

Incidentally, the image processing section 203 need only be configured to estimate the driver's line of sight and is not limited to the configuration illustrated in FIG. 3. For example, the image processing section 203 may utilize the technique of estimating the line of sight from a point of reflection on the cornea illuminated by near-infrared rays and from the center position of the pupil. Alternatively, the image processing section 203 may adopt the technique of estimating the line of sight from the image captured of the driver's by use of machine learning.

As another alternative, the image processing section 203 may perform subject recognition by use of exterior images to detect oncoming vehicles and pedestrians ahead, for example, and outputs what is detected to the driving parameter information generation section 206.

The self-position detection section 204 detects the current position of the vehicle 20 equipped with the driving assistance system 200. For example, the self-position detection section 204 detects the current position by performing positioning upon receipt of GNSS (Global Navigation Satellite System) signals from GNSS satellites (e.g., GPS signals from GPS (Global Positioning System) satellites). Alternatively, the self-position detection section 204 may identify the current position by exchanging signals with wireless access points. As another alternative, the self-position detection section 204 may detect the current position from position information acquired by a mobile terminal having a positioning function or from position information acquired upon receipt of radio waves or electromagnetic waves from wireless stations or the like set up along the roads. The self-position detection section 204 outputs the position information indicative of the detected current position to the driving parameter information generation section 206.

The information acquisition section 205 acquires vehicle exterior information (e.g., surrounding environment, etc.) that cannot be acquired by the first imaging section 201, driver information (e.g., biological information regarding the driver, etc.) that cannot be acquired by the image processing section 203, and vehicle information indicative of the vehicle state (e.g., opened or closed windows, vehicle interior temperature, etc.). The information acquisition section 205 outputs the acquired information to the driving parameter information generation section 206.

The driving parameter information generation section 206 generates driving parameter information that includes, as parameter information, the result of detection of the line of sight by the image processing section 203, the current position detected by the self-position detection section 204, the information acquired by the information acquisition section 205, and travel control information (indicative of speed, steering angle, etc.) supplied from the travel control section 210. The travel control information will be described later. For example, the driving parameter information generation section 206 generates the driving parameter information by tabularizing or mapping the result of detection of the line of sight in the current position, vehicle exterior information such as the surrounding environment, and travel control information. The driving parameter information generation section 206 outputs the generated driving parameter information to the determination section 209.

The communication section 207 communicates with the management apparatus via an external network. Accordingly, the communication section 207 transmits the information generated by the driving assistance system 200 and stored information to the management apparatus and supplies the storage section 208 with the information received from the management apparatus. For example, the communication section 207 communicates with the management apparatus (e.g., server or roadside unit, etc.) that exists on the external network (e.g., the Internet, cloud network, or proprietary network) via a base station or an access point, thereby transmitting the driving parameter information to the management apparatus and receiving optimum parameter information from the management apparatus for use by the determination section 209. The optimum parameter information will be described later.

The storage section 208 includes a magnetic storage device such as a ROM (Read Only Memory), a RAM (Random Access Memory), or an HDD (Hard Disc Drive), a semiconductor storage device, an optical storage device, and a magneto-optical storage device. The storage section 208 stores diverse programs, data, and the like for use by the driving assistance system 200. For example, the storage section 208 stores map data, vehicle-specific information, and the like. Also, the storage section 208 stores the information acquired through the communication section 207, such as the optimum parameter information acquired from the management apparatus.

The determination section 209 acquires, from the storage section 208, the optimum parameter information of which the position information and the surrounding environment are the same as the driving parameter information generated by the driving parameter information generation section 206. The determination section 209 then determines whether there is a danger on the basis of a difference in parameter information between the driving parameter information and each corresponding piece of the optimum parameter information. Upon determining that there is a dangerous state, the determination section 209 outputs information indicative of the difference in parameter information to the travel control section 210 and to the information presentation section 214. For example, the determination section 209 calculates a parameter difference evaluation value reflecting the difference in parameter information and, on the basis of the calculated parameter difference evaluation value, determines whether there is a danger. In a case of determining that there is a dangerous state, the determination section 209 outputs either the parameter difference evaluation value for each piece of parameter information or the parameter difference evaluation value, etc. of the parameter information having a large difference to the travel control section 210 and to the information presentation section 214.

The travel control section 210 generates control signals on the basis of the difference between the result of determination of a danger and on the difference in parameter information and outputs the generated control signals to the driving section 211, the steering section 212, and the braking section 213. Accordingly, the travel control section 210 provides traveling assistance in such a manner as to reduce the difference between the driving parameter information and the optimum parameter information. For example, the travel control section 210 may generate, for each piece of parameter information, a control signal for reducing the difference in parameter information on the basis of the parameter difference evaluation value supplied upon determination of a dangerous state by the determination section 209. Alternatively, the travel control section 210 may generate control signals with respect to the parameter information having a parameter difference evaluation value larger than a predetermined threshold value. Further, the travel control section 210 outputs, to the driving parameter information generation section 206, the travel control information indicative of the control state of the driving section 211, the steering section 212, and the braking section 213.

The driving section 211 provides vehicle speed control. The driving section 211 adjusts the traveling speed of the vehicle in response to the accelerator pedal being operated. Further, on the basis of control signals supplied from the travel control section 210, the driving section 211 performs speed control in such a manner that the traveling speed does not exceed a threshold value indicated by the optimum parameter information.

The steering section 212 provides direction control. The steering section 212 adjusts the traveling direction of the vehicle by changing the steered angle of the steered wheels in response to the steering wheel being operated. Further, on the basis of control signals supplied from the travel control section 210, the steering section 212 performs direction control in such a manner that the traveling position of the vehicle does not exceed a threshold value indicated by the optimum parameter information.

The braking section 213 provides braking control. The braking section 213 applies braking force to the wheels in response to the brake being applied. Further, on the basis of control signals supplied from the travel control section 210, the braking section 213 performs speed control to apply braking force to the wheels in such a manner that the traveling speed does not exceed a threshold value indicated by optimum parameter information.

The information presentation section 214 provides driving assistance by generating driving assistance information, based on the result of determination of a danger and on the difference in parameter information, and by presenting the user with the generated driving assistance information with display or voice for driving assistance. For example, the information presentation section 214 includes a head-up display. The information presentation section 214 displays information such a traveling state and the traveling route in the driver's field of view. Further, in the case where the determination section 209 determines that there is a dangerous state, the information presentation section 214 provides display notifying that there is a large difference between the driving parameter information and the optimum parameter information or display instructing that the difference be reduced. Also, in a case where the information presentation section 214 includes speakers or the like, the information presentation section 214 provides voice output notifying that there is a large difference between the driving parameter information and the optimum parameter information or voice instructing that the difference be reduced. For example, on the basis of the parameter difference evaluation value supplied upon determination of a dangerous state by the determination section 209, the information presentation section 214 presents the driving assistance information regarding either the parameter information having the largest difference in parameter information or the parameter information of which the parameter difference evaluation value is larger than a predetermined threshold value.

### <3. Operations of Driving Assistance System>

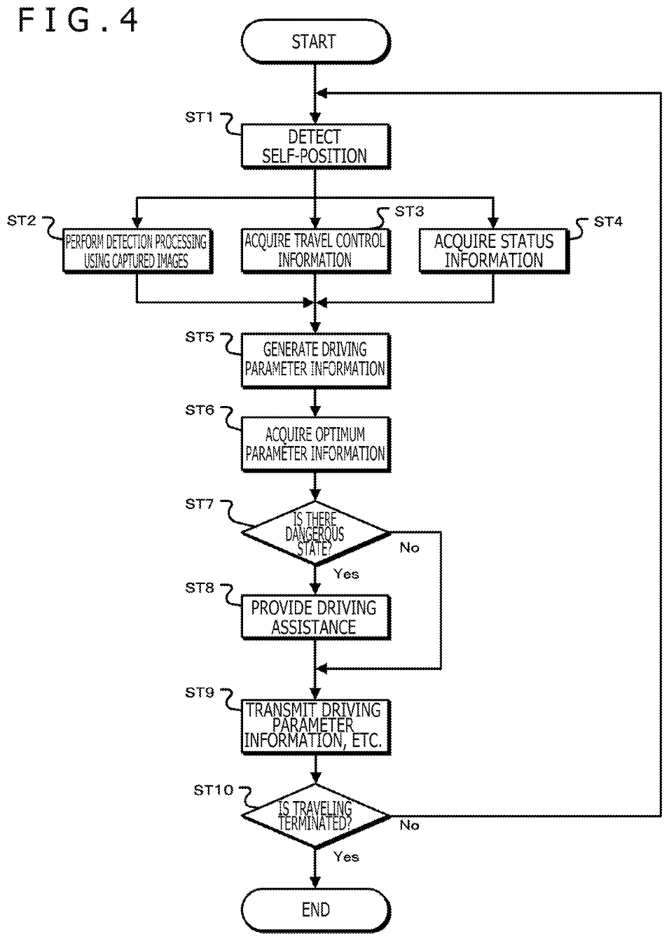

FIG. 4 is a flowchart illustrating operations of the driving assistance system. In step ST1, the driving assistance system 200 detects its own position. The self-position detection section 204 of the driving assistance system 200 detects the current position of the vehicle 20 by use of signals from satellites, for example, before going to steps ST2 through ST4.

In step ST2, the driving assistance system 200 performs detection processing using captured images. The image processing section 203 of the driving assistance system 200 detects, for example, the driver's line of sight by use of images captured of the driver and of the vehicle exterior. Also, using images captured of the vehicle exterior, the image processing section 203 may detect oncoming vehicles and pedestrians ahead, for example. After performing the detection processing using captured images, the image processing section 203 goes to step ST5.

In step ST3, the driving assistance system 200 acquires travel control information. The driving parameter information generation section 206 of the driving assistance system 200 acquires the travel control information generated by the travel control section 210 and goes to step ST5.

In step ST4, the driving assistance system 200 acquires status information. The information acquisition section 205 of the driving assistance system 200 acquires vehicle exterior information and driver information indicative of the state of the vehicle exterior and of the driver, etc. as well as vehicle information, etc., the information not having been acquired in steps ST1 and ST2. The information acquisition section 205 then goes to step ST4.

In step ST5, the driving assistance system 200 generates driving parameter information. The driving parameter information generation section 206 of the driving assistance system 200 generates the driving parameter information that includes the current position detected in step ST1, the information detected in step ST2, the travel control information detected in step ST3, the information acquired in step ST4, and the like. The driving parameter information generation section 206 then goes to step ST6.

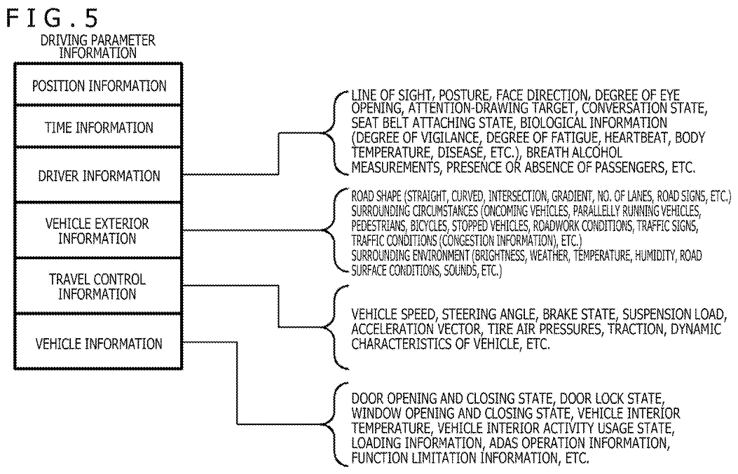

FIG. 5 illustrates information included in the driving parameter information. The driving parameter information includes the parameter information such as position information, time information, driver information, vehicle exterior information, travel control information, and vehicle information. The parameter information further includes the information of which the difference from the optimum parameter information is calculated, the information used for determination of a danger without the difference calculation, and the information used for selecting the optimum parameter information.

The driver information includes information indicative of the driver's line of sight detected by use of the vehicle exterior image and the driver's image. The driver information may include the posture, the face direction, and the eye-opening degree of the driver. Further, the driver information may include an attention-drawing target being gazed at by the driver, a conversation state of the driver, a seat belt attaching state of the driver, biological information regarding the driver (degree of vigilance, degree of fatigue, heartbeat, body temperature, disease), breath alcohol measurements, and the like and information as to the presence or absence of passengers and the like. It is to be noted that, in the driver information, the driver's line of sight, for example, is information of which the difference from the optimum parameter information is calculated. The seat belt attaching state is information used for determination of a danger without the difference calculation.

The vehicle exterior information includes information indicative of the road shape, information indicative of surrounding circumstances, information indicative of the external environment, and the like. The information indicative of the road shape includes information indicating whether, for example, the road is straight, curved, or an intersection, and information indicating the gradient and the number of lanes of the road, road signs, and the like. The information indicative of surrounding circumstances indicates, for example, oncoming vehicles, parallelly running vehicles, pedestrians, bicycles, stopped vehicles, roadwork conditions, traffic signs, traffic conditions (congestion information), and the like. The information indicative of the external environment indicates exterior brightness, weather, temperature, humidity, road surface conditions, sounds, and the like. It is to be noted that, in the vehicle exterior information, the information indicative of the external environment, for example, is used to select the optimum parameter information.

The travel control information includes the information indicative of the vehicle speed and the steering angle. The travel control information may further include information indicative of the brake state, loads on the suspension, an acceleration vector, air pressures of the tires, traction, dynamic characteristics of the vehicle, and the like. It is to be noted that, in the travel control information, the vehicle speed and the steering angle, for example, are the information of which the difference from the optimum parameter information is calculated.

The vehicle information may include the door opening and closing state, the door lock state, the window opening and closing state, the vehicle interior temperature, the vehicle interior activity usage state, loading information, ADAS (Advanced Driver-Assistance Systems) operation information, function limitation information, and the like. It is to be noted that, in the vehicle information, the door opening and closing state, the door lock state, and the vehicle interior activity usage state, for example, are used for determination of a danger without the difference calculation.

It is to be noted that the driving parameter information depicted in FIG. 5 is only for illustrative purposes and that information not depicted in FIG. 5 may also be included. The driving parameter information may be generated using only some pieces of the information depicted in FIG. 5.

In step ST6, the driving assistance system 200 acquires the optimum parameter information. The determination section 209 of the driving assistance system 200 acquires the optimum parameter information regarding the position and the surrounding environment indicated by the driving parameter information generated in step ST5, from the storage section 208 or from the management apparatus 30 via the communication section 207. The determination section 209 then goes to step ST7.

In step ST7, the driving assistance system 200 determines whether the driving state constitutes a dangerous state. The determination section 209 of the driving assistance system 200 determines whether the current situation is a dangerous state on the basis of the driving parameter information generated in step ST5 and the optimum parameter information acquired in step ST6. In a case of determining that there is no dangerous state because the difference between the driving parameter information and the optimum parameter information falls within an acceptable range, the determination section 209 goes to step ST9. In a case of determining that there is a dangerous state because the acceptable range is being exceeded, the determination section 209 goes to step ST8.

Whether or not the driving state constitutes a dangerous state is determined, for example, by use of the parameter difference evaluation value reflecting the difference in parameter information between the driving parameter information and each corresponding piece of the optimum parameter information.

The differences in parameter information are a difference in line of sight, a difference in speed, and a difference in steering angle, for example. That means the units of the differences may not necessarily be consistent. Thus, on the assumption that the parameter difference evaluation value corresponding to a predetermined maximum difference is “Emax” and that the parameter difference evaluation value with no difference is “0,” the differences in parameter information are normalized. What is then used for determination of a dangerous state is the parameter difference evaluation value reflecting the difference in each piece of parameter information calculated by use of the driving parameter information and the optimum parameter information.

The determination section 209 determines that there is a dangerous state in a case where the total value of the parameter difference evaluation values of each piece of parameter information exceeds a predetermined threshold value (acceptable range). In a case where the total value of the parameter difference evaluation values of each piece of parameter information is to be calculated, the parameter information may be weighted, and the weighted parameter difference evaluation values may be used to calculate the total value.

As another alternative, not only the information for calculating the difference from the optimum parameter information but also the information for determination of a danger without the difference calculation may be used to determine whether there is a dangerous state. Here, it is assumed that the parameter difference evaluation values of m pieces of information for calculating the difference are “Pa1 through Pam” and that the parameter evaluation values set for n pieces of information for determination of a danger without the difference calculation are “Pb1 through Pbn.” It is further assumed that the weights on the parameter difference evaluation values are “W1 through Wm.” In this case, a total value PT is calculated on the basis of the following mathematical expression (1) for example, so that a dangerous state is determined to be present in a case where the total value PT is larger than a threshold value.

[Math. 1]

PT=Σᵢ₌₁^{m}WᵢPaᵢ+Σⱼ₌₁ⁿPbⱼ (1)

Further, even in a case where the total value is not larger than the threshold value, the parameter difference evaluation value may be compared with a predetermined threshold value (acceptable range) for each piece of parameter information and, in a case where the parameter difference evaluation value is larger than the threshold value for any piece of parameter information, a dangerous state may be determined to be present. It is to be noted that the method of determining whether or not there is a dangerous state is not limited to what was discussed above as long as the driving parameter information and the optimum parameter information are used. For example, without the total value being calculated, the parameter difference evaluation value may be compared with a predetermined threshold value (acceptable range) for each piece of parameter information and, in a case where the parameter difference evaluation value is larger than the threshold value for any piece of parameter information, a dangerous state may be determined to be present.

In step ST8, the driving assistance system 200 provides driving assistance. The driving assistance system 200 presents the driving assistance information and/or provides traveling assistance as the driving assistance. In a case of presenting the driving assistance information, the driving assistance system 200 causes the information presentation section 214 to output, with an image or voice, as the driving assistance information, information indicating the deviation of the current driving state from the optimum driving state or information instructing that the deviation be reduced. Further, in a case of providing traveling assistance, the driving assistance system 200 performs assistance operations in keeping with the deviation state. In response to the deviation of the current driving state from the optimum driving state, the driving assistance system 200 causes the travel control section 210 to generate control signals and outputs the generated control signals to the driving section 211, the steering section 212, and the braking section 213. In this manner, the driving assistance system 200 performs assistance operations such as to reduce the deviation of the current driving state from the optimum driving state. Having performed the assistance operations, the driving assistance system 200 goes to step ST9.

In step ST9, the driving assistance system 200 transmits the driving parameter information and other data. The communication section 207 of the driving assistance system 200 transmits, to the management apparatus 30, the driving parameter information generated in step ST7 and information as to the driving parameter information and regarding the driving assistance and traveling assistance. The communication section 207 then goes to step ST10.

In step ST10, the driving assistance system 200 determines whether traveling is terminated. In a case of determining that traveling is terminated, the driving assistance system 200 terminates its operations. In a case where traveling is to be continued, the driving assistance system 200 repeats steps ST1 through ST9, to forestall the occurrence of a danger.

It is to be noted that, whereas FIG. 4 depicts the case in which steps ST2 through ST4 are processed in parallel, these processes may alternatively be carried out successively. As another alternative, the processes of steps ST2, ST3, and ST4 need not be performed in total. Instead, any one or more of these steps may be carried out.

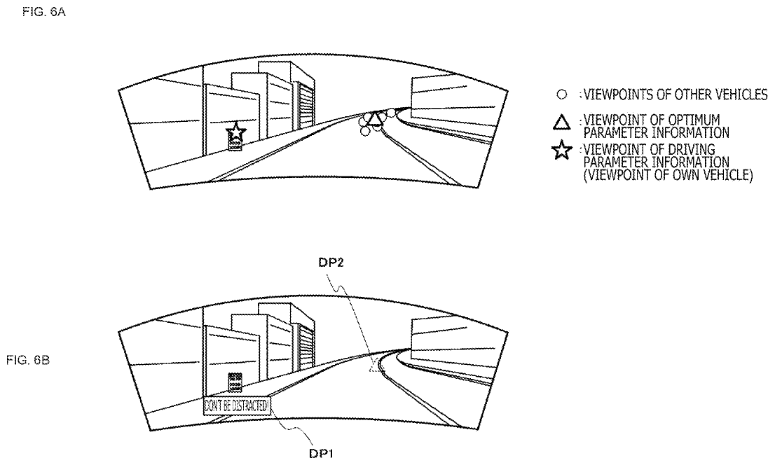

Explained next are operation examples of the driving assistance system 200. FIG. 6 illustrates cases in which the driving parameter information includes the driver information indicative of the driver's line of sight. Subfigure (a) in FIG. 6 depicts the driver's line of sight indicated by driver parameter information and the line of sight indicated by the optimum parameter information. For example, the driver's line of sight is positioned obliquely to the right front as indicated by a star sign. Circle signs point to the lines of sight of the drivers of other vehicles that have previously moved past the current position. A triangle sign indicates the line of sight of the optimum parameter information generated by statistical processing, etc. of the lines of sight of the drivers of the other vehicles having previously moved past the current position.

In a case where the driver's line of sight deviates from the line of sight of the optimum parameter information as described above, the driver's attention to the road ahead is distracted, and there is a possibility that the vehicle may deviate from the traveling lane. Further, when the driver returns the line of sight to the road ahead, in a case where the vehicle is about to deviate from the traveling lane, an abrupt steering operation causes the vehicle to swerve, for example, and the driving becomes unstable.

Meanwhile, the driving assistance system to which the information processing apparatus of the present technology is applied provides driving assistance according to the difference between the driving parameter information generated by the vehicle on one hand, and the optimum parameter information applicable to the current position and to the current surrounding environment on the other hand. For example, if the line of sight indicated by the optimum parameter information is positioned on the right side ahead because the road ahead makes a right turn and if the line of sight indicated by the driving parameter information is positioned obliquely to the left front due to the destruction of the driver, so that the difference in line of sight exceeds an acceptable range, the information presentation section 214 presents a line-of-sight deviation alert DP1 as depicted in Subfigure (b) in FIG. 6, for example. It is to be noted that, displaying the line-of-sight deviation alert DP1 near the driver's line of sight allows the driver to easily recognize the deviation. Alternatively, the information presentation section 214 may display an identification mark DP2 indicative of the line of sight indicated by the optimum parameter information. In such a manner, in a case where the difference between the driving parameter information and the optimum parameter information exceeds the acceptable range, the present technology enables the driving assistance information for reducing the difference to be presented, to forestall the occurrence of a danger.

In a case where the driving parameter information and the optimum parameter information include travel control information indicative of the vehicle speed and the steering angle, if the vehicle entering a curve travels at too high a speed or too small a steering angle, for example, so that the difference from the vehicle speed or steering angle indicated by the optimum parameter information exceeds an acceptable range, then traveling assistance is performed in such a manner as to reduce the difference and to let the vehicle speed and traveling direction fall within their acceptable ranges. In such a manner, traveling assistance is appropriately provided according to this technology. Therefore, it is possible not only to forestall the occurrence of a danger but also to complement the driving ability of an inexperienced driver.

Also, when the optimum parameter information applicable to the current surrounding environment is used, it is possible to provide driving assistance according to changes in the surrounding environment. For example, in rainy conditions, because of poor visibility, it becomes difficult to detect pedestrians who are about to cross the street or are standing on the road shoulder. Thus, when the lines of sight of many vehicles are positioned on the road shoulder, the line of sight indicated by the optimum parameter information points to the proximity of the road shoulder. As a result, in a case where the weather indicated by the driving parameter information is in rainy conditions, driving assistance is performed in such a manner that the line of sight is positioned near the road shoulder. Even when the vehicle exterior state is changed, it is thus possible to forestall the occurrence of a danger.

Further, if the driving parameter information and the optimum parameter information include time information, driving assistance can be performed in keeping with the changes in the traveling environment in a case where the traveling environment is changed with traveling time. For example, in a time slot in which there are many pedestrians crossing ahead of the vehicles, etc., many vehicles travel at low speeds, so that the traveling speed indicated by the optimum parameter information is low. In such a case, if the traveling speed indicated by the driving parameter information is a speed according to the state in which there are few pedestrians, driving assistance is performed in such a manner that the traveling speed indicated by the driving parameter information attains the traveling speed indicated by the optimum parameter information. Therefore, it is possible to forestall the occurrence of a danger even if the traveling environment changes over time.

Furthermore, a moving object may be identified in an exterior image by detecting the difference between external environment information including only the static object corresponding to the self-position of the vehicle on one hand, and the information based on the exterior image acquired by the first imaging section 201 on the other hand. For example, in a state where there is no moving object in the exterior image acquired by the first imaging section 201, there is a match between the external environment information and the information based on the exterior image. On the other hand, in a case where there is a difference between the external environment information and the information based on the exterior image, that difference is determined to be a moving object. Then, on the basis of whether or not the driver's line of sight is appropriately directed to the moving object, the difference between the driving parameter information and the optimum parameter information may be detected.

### <4. Configuration and Operations of Management Apparatus>

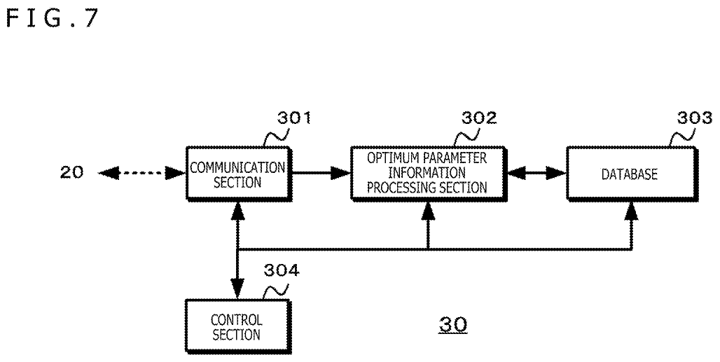

A configuration and operations of the management apparatus are explained next. FIG. 7 illustrates a configuration of the management apparatus. The management apparatus 30 includes a communication section 301, an optimum parameter information processing section 302, a database 303, and a control section 304.

The communication section 301 communicates with the vehicle 20. Accordingly, the communication section 301 receives, from the vehicle 20, the driving parameter information indicative of the state and the current position of the vehicle or of its driver, etc. or transmits the optimum parameter information to the vehicle 20.

On the basis of multiple pieces of the driving parameter information indicative of the state and the current position of the vehicle or of its driver, the optimum parameter information processing section 302 generates the optimum parameter information indicative of the optimum state of the vehicle or of its driver in a given position. For example, the optimum parameter information processing section 302 performs statistical processing by use of the driving parameter information that is applicable to the same position and to the same surrounding environment and that is supplied from multiple vehicles. Accordingly, the optimum parameter information processing section 302 calculates a mean position or a mode position of the lines of sight, a mean value or a mode value of the speeds, and a mean value or a mode value of the steering angles, etc. before generating, for each position and for each surrounding environment, the optimum parameter information including parameter information indicative of the means values or the mode values, etc. Also, the optimum parameter information processing section 302 updates the already generated optimum parameter information on the basis of newly acquired driving parameter information. The optimum parameter information processing section 302 may generate or update the optimum parameter information by use of not only the driving parameter information supplied from multiple vehicles but also accident information as well. For example, in a case where the cause of an accident is a vehicle deviating from the lane, the optimum parameter information may be adjusted to let the travel position be well inside the lane boundaries. Also, the optimum parameter information may include accident information indicating the occurrence of an accident ahead, the cause of the accident, or the like. The optimum parameter information processing section 302 stores the optimum parameter information thus generated or updated into the database 303.

On the basis of signals received by the communication section 301, the control section 304 controls the optimum parameter information processing section 302 and the database 303 to generate and update the optimum parameter information. The control section 304 further performs a process of transmitting a response signal indicative of the optimum parameter information from the communication section 301 to the vehicle 20.

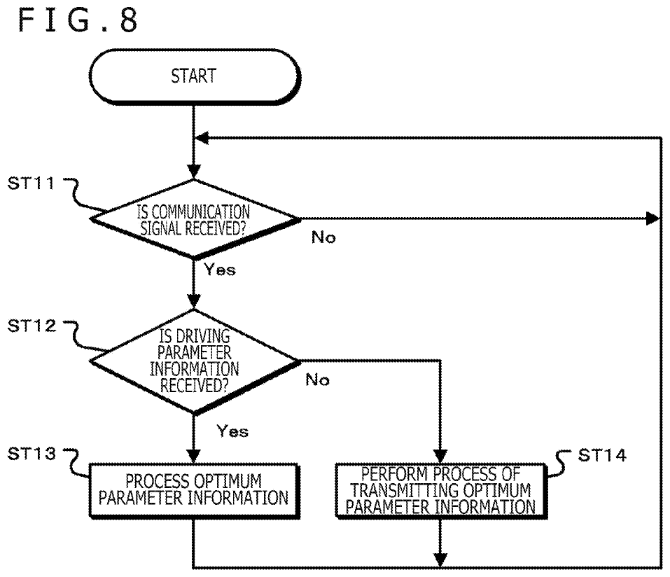

FIG. 8 is a flowchart illustrating operations of the management apparatus. In step ST11, the management apparatus determines whether a communication signal is received from a vehicle. In a case of receiving the communication signal from the vehicle, the communication section 301 of the management apparatus 30 goes to step ST12. In a case where the communication signal is not received, the communication section 301 returns to step ST11.

In step ST12, the management apparatus determines whether the driving parameter information is received. In a case where the received communication signal is a signal indicative of the driving parameter information, the control section 304 of the management apparatus 30 goes to step ST13. In a case where the received communication signal is a signal indicative of a request for the optimum parameter information, the control section 304 goes to step ST14.

In step ST13, the management apparatus processes the optimum parameter information. The control section 304 of the management apparatus 30 controls the optimum parameter information processing section 302 to generate or update the optimum parameter information on the basis of the driving parameter information received in step ST1l. Then, the control section 304 stores the generated or updated optimum parameter information into the database 303 and returns to step ST11.

In step ST14, the management apparatus performs a process of transmitting the optimum parameter information. The control section 304 of the management apparatus 30 acquires, from the database 303, the optimum parameter information requested from the vehicle 20, performs the process of transmitting the acquired optimum parameter information from the communication section 301 to the vehicle 20, and returns to step ST11.

According to the present technology described above, the driving parameter information is transmitted from the vehicle to the management apparatus. On the basis of the driving parameter information transmitted from multiple vehicles, the management apparatus generates the optimum parameter information for enabling safer traveling in each travel position and in each surrounding environment and provides the vehicles with the optimum parameter information thus generated. Even in a location to be traveled for the first time, the vehicle can thus travel safely with ease by use of the optimum parameter information.

In addition, the weights and the threshold values for the parameter difference evaluation values may be set either by the vehicle 20 or by the management apparatus 30. For example, the determination section 209 of the vehicle 20 may perform learning by use of the state of the vehicle 20 or of the driver of the vehicle 20, before setting the weights and the threshold values in keeping with the state of the vehicle 20 or of its driver. For example, in a case where the driver's line of sight or the driver's handling of the vehicle tends to incur a dangerous state, the weight on the parameter information related to the cause of the dangerous state is increased or the threshold value for that parameter information is reduced such that a dangerous state is determined more sensitively. On the other hand, in a case where the driver's handling of the vehicle or the like has the characteristic of little dangerousness, the weight on the parameter information related to that characteristic may be reduced or the threshold value for that parameter information may be increased such that a dangerous state may be determined less sensitively. Also, the management apparatus 30 may perform learning by use of the state of each vehicle or of its driver and set the weights and the threshold values in consideration of variations in the parameter information, etc. Further, when the accident information is included in the optimum parameter information, the management apparatus 30 can notify the drivers of the locations where accidents tend to occur and thereby prompt the drivers to drive carefully.

The series of the processes described above may be executed either by hardware, by software, or by a combination of both. In a case where these processes are to be carried out by software, a program with processing sequences recorded therein is installed into a memory of a computer built with dedicated hardware for execution thereby. Alternatively, the program may be installed into a general-purpose computer capable of performing diverse processes for execution thereby.

For example, the program may be recorded beforehand on a hard disc, an SSD (Solid State Drive), or a ROM (Read Only Memory) serving as a recording medium. Alternatively, the program may be stored (recorded) temporarily or permanently on a removable recording medium such as a flexible disc, a CD-ROM (Compact Disc Read Only Memory), a MO (Magneto optical) disc, a DVD (Digital Versatile Disc), a BD (Blu-Ray Disc (registered trademark)), a magnetic disc, or a semiconductor memory card. These removable recording media may be offered as what is called packaged software.

As another alternative, besides being installed from a removable recording medium into the computer, the program may be transferred from a download site to the computer by wire or wirelessly over a network such as a LAN (Local Area Network) or the Internet. The computer can receive the program thus transferred and have it installed onto an internal recording medium such as a hard disc.

It is to be noted that the advantageous effects stated in this description are only examples and are not limitative of the present technology. There may be additional advantageous effects derived from and not covered by this description. Further, the present technology should not be limited to the embodiment discussed above when interpreted. The embodiment is presented only as illustrations in disclosing the present technology. It is evident that many alternatives, modifications, and variations of the embodiment will become apparent to those skilled in the art without departing from the spirit and scope of this technology. In other words, the scope of the present technology should be determined in consideration of the appended claims.

The information processing apparatus according to the present technology may also be configured as follows.

(1)

An information processing apparatus including:

a determination section configured to determine whether there is a danger on the basis of a difference between driving parameter information indicative of a state of a vehicle or of a driver thereof in a current position on one hand, and optimum parameter information indicative of an optimum state of the vehicle or of the driver in the current position and in a current surrounding environment on the other hand.

(2)

The information processing apparatus as stated in paragraph (1) above, further including:

a driving parameter information generation section configured to generate the driving parameter information,

in which the driving parameter information generation section causes the driving parameter information to include, as parameter information, either travel control information regarding the vehicle or information detected by use of an image captured of the driver and information indicative of the current position.

(3)

The information processing apparatus as stated in paragraph (2) above, further including:

an information acquisition section configured to acquire a vehicle exterior state including the surrounding environment,

in which the driving parameter information generation section causes the driving parameter information to include, as parameter information, information acquired by the information acquisition section.

(4)

The information processing apparatus as stated in paragraph (2) or (3) above, further including:

an image processing section configured to detect a line of sight of the driver by performing image processing by use of an image captured of the driver,

in which the driving parameter information generation section causes the driving parameter information to include, as parameter information, information indicative of the line of sight of the driver detected by the image processing section.

(5)

The information processing apparatus as stated in any one of paragraphs (1) through (4) above, in which the determination section calculates a parameter difference evaluation value reflecting a difference in parameter information between the driving parameter information and each corresponding piece of the optimum parameter information, the determination section further determining whether there is a danger by use of the calculated parameter difference evaluation value and a predetermined threshold value.

(6)

The information processing apparatus as stated in paragraph (5) above, in which the determination section determines whether there is a danger on the basis of a result of comparison between a total value of the parameter difference evaluation values and a predetermined threshold value.

(7)

The information processing apparatus as stated in paragraph (6) above, in which the determination section determines whether there is a danger further by use of a result of comparison between the parameter difference evaluation value and a threshold value set beforehand for each piece of parameter information.

(8)

The information processing apparatus as stated in any one of paragraphs (5) through (7) above, in which the determination section sets a weight on the parameter difference evaluation value, the determination section further determining whether there is a danger on the basis of the weighted parameter difference evaluation value.

(9)

The information processing apparatus as stated in paragraph (8) above, in which the weight or the threshold value is set for each driver.

(10)

The information processing apparatus as stated in paragraph (5) above, further including:

a driving assistance section configured to provide driving assistance, based on the result of determination by the determination section and on the parameter difference evaluation value.

(11)

The information processing apparatus as stated in paragraph (10) above, in which, in a case where the determination section determines that there is a dangerous state, the driving assistance section presents driving assistance information.

(12)

The information processing apparatus as stated in paragraph (11) above, in which the driving assistance section presents driving assistance information regarding parameter information having a large difference on the basis of the parameter difference evaluation value.

(13)

The information processing apparatus as stated in any one of paragraphs (10) through (12) above, in which, in a case where the determination section determines that there is a dangerous state, the driving assistance section provides traveling assistance such as to reduce a difference of parameter information having a large difference on the basis of the parameter difference evaluation value.

The management apparatus according to the present technology may also be configured as follows.

(1)

A management apparatus including:

an optimum parameter information processing section configured to generate optimum parameter information indicative of an optimum state of a vehicle or of a driver thereof in a given position on the basis of multiple pieces of driving parameter information indicative of a state and a current position of the vehicle or of the driver.

(2)

The management apparatus as stated in paragraph (1) above, in which the optimum parameter information processing section updates the generated optimum parameter information by use of newly acquired driving parameter information.

(3)

The management apparatus as stated in paragraph (1) or (2) above, in which the optimum parameter information processing section performs, using accident information, a process of correcting the optimum parameter information indicative of a position within a predetermined range including a position where an accident has occurred.

(4)

The management apparatus as stated in any one of paragraphs (1) through (3) above, further including:

a control section configured to provide the vehicle, upon request therefrom, with the optimum parameter information generated by the optimum parameter information processing section.

(5)

The management apparatus as stated in any one of paragraphs (1) through (5) above, further including:

a communication section configured to receive the driving parameter information and a request for the optimum parameter information and to transmit the requested optimum parameter information to the vehicle having issued the request for the optimum parameter information.

### REFERENCE SIGNS LIST

10: Information processing system
20: Vehicle
30: Management apparatus
40: Network
200: Driving assistance system
201: First imaging section
202: Second imaging section
203: Image processing section
204: Self-position detection section
205: Information acquisition section
206: Driving parameter information generation section
207, 301: Communication section
208: Storage section
209: Determination section
210: Travel control section
211: Driving section
212: Steering section
213: Braking section
214: Information presentation section
302: Optimum parameter information processing section
303: Database
304: Control section

1. An information processing apparatus comprising:
a determination section configured to determine whether there is a danger on a basis of a difference between driving parameter information indicative of a state of a vehicle or of a driver thereof in a current position on one hand, and optimum parameter information indicative of an optimum state of the vehicle or of the driver in the current position and in a current surrounding environment on the other hand.

2. The information processing apparatus according to claim 1, further comprising:
a driving parameter information generation section configured to generate the driving parameter information,
wherein the driving parameter information generation section causes the driving parameter information to include, as parameter information, either travel control information regarding the vehicle or information detected by use of an image captured of the driver and information indicative of the current position.

3. The information processing apparatus according to claim 2, further comprising:
an information acquisition section configured to acquire a vehicle exterior state including the surrounding environment,
wherein the driving parameter information generation section causes the driving parameter information to include, as parameter information, information acquired by the information acquisition section.

4. The information processing apparatus according to claim 2, further comprising:
an image processing section configured to detect a line of sight of the driver by performing image processing by use of an image captured of the driver,
wherein the driving parameter information generation section causes the driving parameter information to include, as parameter information, information indicative of the line of sight of the driver detected by the image processing section.

5. The information processing apparatus according to claim 1,
wherein the determination section calculates a parameter difference evaluation value reflecting a difference in parameter information between the driving parameter information and each corresponding piece of the optimum parameter information, the determination section further determining whether there is a danger by use of the calculated parameter difference evaluation value and a predetermined threshold value.

6. The information processing apparatus according to claim 5, wherein the determination section determines whether there is a danger on a basis of a result of comparison between a total value of the parameter difference evaluation values and a predetermined threshold value.

7. The information processing apparatus according to claim 6, wherein the determination section determines whether there is a danger further by use of a result of comparison between the parameter difference evaluation value and a threshold value set beforehand for each piece of parameter information.

8. The information processing apparatus according to claim 5, wherein the determination section sets a weight on the parameter difference evaluation value, the determination section further determining whether there is a danger on a basis of the weighted parameter difference evaluation value.

9. The information processing apparatus according to claim 8, wherein the weight or the threshold value is set for each driver.

10. The information processing apparatus according to claim 5, further comprising:
a driving assistance section configured to provide driving assistance, based on the result of determination by the determination section and on the parameter difference evaluation value.

11. The information processing apparatus according to claim 10, wherein, in a case where the determination section determines that there is a dangerous state, the driving assistance section presents driving assistance information.

12. The information processing apparatus according to claim 11, wherein the driving assistance section presents driving assistance information regarding parameter information having a large difference on a basis of the parameter difference evaluation value.

13. The information processing apparatus according to claim 10, wherein, in a case where the determination section determines that there is a dangerous state, the driving assistance section provides traveling assistance such as to reduce a difference of parameter information having a large difference on a basis of the parameter difference evaluation value.

14. An information processing method comprising:
causing a determination section to determine whether there is a danger on a basis of a difference between driving parameter information indicative of a state of a vehicle or of a driver thereof in a current position on one hand, and optimum parameter information indicative of an optimum state of the vehicle or of the driver in the current position and in a current surrounding environment on the other hand.

15. A driving assistance system comprising:
an imaging section configured to capture an image of a driver;
a travel control section configured to provide travel control of a vehicle;
an information acquisition section configured to acquire status information indicative of a surrounding environment;
a driving parameter information generation section configured to generate driving parameter information by use of, as parameter information, either travel control information generated by the travel control section or information detected by use of the captured image acquired by the imaging section and information indicative of a current position;
a determination section configured to determine whether there is a danger on a basis of a difference between the driving parameter information generated by the driving parameter information generation section on one hand, and optimum parameter information indicative of an optimum state of the vehicle or of the driver thereof in the current position and in a current surrounding environment on the other hand; and
a driving assistance section configured to provide driving assistance on a basis of a result of determination by the determination section.
